(19) United States
(12) Patent Application Publication
(10) Pub. No.: US 2018/0018452 A1
(43) Pub. Date: Jan. 18, 2018

(54) NON-CONTACT IDENTITY VERIFICATION DEVICE, NON-CONTACT IDENTITY VERIFICATION SYSTEM, AND NON-CONTACT IDENTITY VERIFICATION METHOD

(71) Applicants: DARREN TIEN-CHI LEE, Tustin, CA (US); JENG LUNG LI, Taichung City (TW)

(72) Inventors: DARREN TIEN-CHI LEE, Tustin, CA (US); JENG LUNG LI, Taichung City (TW)

(21) Appl. No.: 15/625,355

(22) Filed: Jun. 16, 2017

(30) Foreign Application Priority Data
Jul. 14, 2016 (TW) 105122282

(51) Int. Cl. G06F 21/34; H04L 9/32; G06F 21/32

(52) U.S. Cl. CPC G06F 21/34; G06F 21/32; H04L 9/3231

(57) ABSTRACT

The present invention relates to a non-contact identity verification device and system, and a method thereof, comprising: a physiological characteristic detector, an identification unit, and a transmission unit. The physiological characteristic detector detects a physiological signal of a user. The identification unit compares the physiological signal of a user with a physiological characteristic check value and generates a comparison information. The transmission unit transmits the comparison information. Through a verification technology of the present invention, a user can be verified rapidly and conveniently, recognition stability is very high, and personal data of the user can be adequately protected.

### BACKGROUND OF THE INVENTION

### 1. Field of the Invention

The present invention relates to identity verification technologies, and in particular, to a non-contact identity verification device and system and a method thereof.

### 2. Description of the Related Art

As the society develops rapidly and science and technology change constantly, nowadays most electronic systems or devices (for example, an access control system, a subscriber identity module (SIM) of a mobile phone or an automated teller machine (ATM)) require a user to enter verification information such as a password or a subscriber personal identification number (PIN) to perform identity verification. The user can gain access, use a mobile phone, or perform withdrawal only when the verification succeeds, so as to ensure the safety of the physical body, information or even property of the user. However, once a simple password or subscriber PIN is stolen by a malicious person, an electronic system or device that uses the password or subscriber PIN is cracked. Therefore, it can be known that a conventional password or subscriber PIN cannot adequately protect the safety of the user.

In view of this, a great variety of verification manners are provided commercially to improve the security of a user account. The verification manners generally include contact verification and non-contact verification. In the contact verification, a verification device can perform identity verification of a user only before the user is contacted with the verification device. For example, in the US patent publication No. US2014/0210589, fingerprint recognition is used to verify the identity of a user, to confirm that the user is in fact an owner of a smart card. For another example, in the US patent Publication No. US2015/0235227, a wrist device is used to obtain a physiological characteristic of a user, the physiological characteristic is compared with a preset physiological characteristic, and when the physiological characteristic is consistent with the preset physiological characteristic, it indicates that verification succeeds. In the non-contact verification, a user does not need to be contacted with a verification device, and the verification device performs identity verification in a manner of sensing the user wirelessly. For example, nowadays, speech recognition, facial recognition, and iris recognition develop rapidly, and can all be used to verify the identity of a user rapidly and accurately, thereby improving convenience and precision of identity verification of the user.

However, all the foregoing verification manners have room for improvement. For example, in the contact verification, if a user wears thick clothes or is sweaty or dirty, the speed and accuracy of verification of a verification device are reduced. In the non-contact verification, when speech recognition is used to perform identity verification, if a user has an impaired vocal cord due to an illness (for example, a cold) or an injury or an ambient environment is too noisy, or when facial recognition is used to perform verification, if ambient light of a user is dim or the face of a user has a large-area wound or is masked, recognition becomes difficult or even cannot be performed, resulting in a problem that verification cannot succeed. In a biometric recognition technology, iris recognition has the most precise recognition; however, related apparatuses have an excessively high cost. If a user wears special contact lenses (for example, colored or patterned contact lenses), recognition also becomes difficult or cannot be performed. Moreover, long-time use of iris recognition of a user may cause a lesion to the eyes. For example, an infrared ray for iris recognition may cause cataracts of the eyes or even burn the retinas and the corneas. It can be known that long-time use of iris recognition may cause severe damage to a human body.

In a currently developed human-body physiological characteristic sensing technology, for example, the US patent publication No. 2014/0180057, an ultra wideband (UWB) sensing technology is used to detect a blood vessel diameter of a user. For another example, in the Taiwan patent No. 1495452, a nanosecond pulse near-field sensing (NPNS) technology is used to detect a pulse of a user. Such sensing technologies are currently applied to only detection of physiological characteristics, but are not applied to identity verification.

Moreover, in the verification technologies disclosed above, for both the contact verification and the non-contact verification, sensed physiological information of a user is transmitted to a rear-end apparatus or system to perform comparison and verification, and the physiological information is not specially protected, so that the physiological information of the user may be stolen or tampered easily, thereby jeopardizing the security of personal information of the user and the security of a verification device.

Therefore, how to design a verification technology that is harmless to a human body, saves verification information of a user properly, and has a recognition capability insusceptible to personal factors or an external environment is a commercial demand and is also a problem to be resolved.

### SUMMARY OF THE INVENTION

A main objective of the present invention is to provide a non-contact identity verification device and system and a method thereof, which can verify a user rapidly and conveniently and causes no harm to a human body.

Another objective of the present invention is to provide a non-contact identity verification device and system and a method thereof, which have a recognition capability insusceptible to personal factors or an external environment and provide very high recognition stability.

Yet another objective of the present invention is to provide a non-contact identity verification device and system and a method thereof, which provide high security of personal information and can prevent leakage of personal information of a user.

The present invention provides a non-contact identity verification device, including:

a physiological characteristic detector for detecting a physiological characteristic of a human body and generating at least one piece of physiological characteristic verification information;

a control module, having a physiological characteristic computation unit for converting the at least one piece of physiological characteristic verification information into at least one physiological characteristic verification value;

a key unit for encrypting and storing at least one physiological characteristic check value;

an identification unit for comparing the physiological characteristic verification value with the decrypted physiological characteristic check value, and generating a comparison information; and

a transmission unit for transferring, in a wired or wireless transmission manner, the comparison information generated by the identification unit.

Preferably, the physiological characteristic computation unit has at least one physiological characteristic computation method; the at least one piece of physiological characteristic verification information is converted into the at least one physiological characteristic verification value through the at least one physiological characteristic computation method; and the key unit has at least one key computation method, and the at least one physiological characteristic check value is encrypted and decrypted through the key computation method.

Preferably, the non-contact identity verification device further comprising: a security element, wherein the key unit and the identification unit are disposed in the security element.

Preferably, the non-contact identity verification device further comprising: a power source module, wherein the power source module is capable of supplying power to the physiological characteristic detector, the control module, the key unit, the identification unit and/or the transmission unit.

Preferably, the control module further comprises a preprocessing unit, wherein the preprocessing unit first performs preprocessing on the at least one piece of physiological characteristic verification information; and the physiological characteristic computation unit then converts the at least one piece of preprocessed physiological characteristic verification information into the at least one physiological characteristic verification value.

Preferably, the physiological characteristic detector performs detection by using a nanosecond pulse near-field sensing (NPNS) technology or an ultra wideband (UWB) sensing technology.

The present invention also provides a non-contact identity verification device, including:

a physiological characteristic detector for detecting a physiological characteristic of a human body in a non-contact manner and generating at least one piece of physiological characteristic verification information;

a control module, having a physiological characteristic computation unit, the physiological characteristic computation unit converting the at least one piece of physiological characteristic verification information into at least one physiological characteristic verification value;

a key unit for prestoring at least one physiological characteristic check value;

an identification unit for comparing the physiological characteristic verification value with the physiological characteristic check value and generating a comparison information; and

a transmission unit for transferring, in a wired or wireless transmission manner, the comparison information generated by the identification unit.

Moreover, the present invention also provides a non-contact identity verification system, including: a verification device and an external device, wherein:

the verification device includes: a physiological characteristic detector, a control module, and a transmission unit, wherein the physiological characteristic detector may detect a physiological characteristic of a human body and generate at least one piece of physiological characteristic verification information; and the control module has a physiological characteristic computation unit and an identification unit, the physiological characteristic computation unit converting the at least one piece of physiological characteristic verification information into at least one physiological characteristic verification value;

the external device includes: a key unit and a communication unit, wherein the key unit encrypts and stores at least one physiological characteristic check value, and the communication unit transmits the at least one physiological characteristic check value to the identification unit via the transmission unit of the verification device; and

the identification unit of the verification device compares the physiological characteristic verification value with the decrypted physiological characteristic check value and generates a comparison information, and the transmission unit may transfer the comparison information to the communication unit of the external device.

Preferably, the non-contact identity verification system further comprising: a security element, disposed in the external device, wherein the key unit is disposed in the security element.

The present invention further provides a non-contact identity verification system, including: an authentication device and an external device, wherein:

the authentication device includes: a key unit, an identification unit, and a transmission unit, wherein the key unit encrypts and stores at least one physiological characteristic check value;

the external device includes: a physiological characteristic detector, a control module, and a communication unit, wherein the physiological characteristic detector may detect a physiological characteristic of a human body and generate at least one piece of physiological characteristic verification information; the control module has a physiological characteristic computation unit, the physiological characteristic computation unit converting the at least one piece of physiological characteristic verification information into at least one physiological characteristic verification value; and the communication unit transfers the physiological characteristic verification value to the identification unit via the transmission unit of the authentication device; and

the identification unit of the authentication device compares the physiological characteristic verification value with the decrypted physiological characteristic check value and generates a comparison information, and the transmission unit may transfer the comparison information to the communication unit of the external device.

Preferably, the authentication device further comprises a security element, and the key unit and the identification unit are disposed in the security element.

The present invention further provides a non-contact identity verification system, including: an authentication device and an external device, wherein:

the authentication device includes: a key unit, a control module, an identification unit, and a transmission unit, wherein the key unit encrypts and stores at least one physiological characteristic check value; and the control module has a physiological characteristic computation unit;

the external device includes: a physiological characteristic detector and a communication unit, wherein the physiological characteristic detector detects a physiological characteristic of a human body in a non-contact manner and generates at least one piece of physiological characteristic verification information; and the communication unit may transfer the physiological characteristic verification information to the control module via the transmission unit of the authentication device; and

the physiological characteristic computation unit of the control module converts the at least one piece of physiological characteristic verification information into at least one physiological characteristic verification value; and the identification unit compares the physiological characteristic verification value with the decrypted physiological characteristic check value and generates a comparison information, and the transmission unit may transfer the comparison information to the communication unit of the external device.

Furthermore, the present invention provides a non-contact identity verification method, including an identity verification procedure, wherein the identity verification procedure includes the following steps:

Step 1: detecting and acquiring, by a physiological characteristic detector, at least one piece of physiological characteristic verification information of a user;

Step 2: converting, by a control module, the at least one piece of physiological characteristic verification information into at least one physiological characteristic verification value through a physiological characteristic computation unit, and transferring the physiological characteristic verification value to an identification unit;

Step 3: decrypting, by the control module, at least one encrypted physiological characteristic check value stored in a key unit, and transferring the decrypted physiological characteristic check value to the identification unit; and

Step 4: comparing, by the identification unit, the physiological characteristic verification value with the physiological characteristic check value, and generating a comparison information.

Preferably, an identity registration procedure is further included, wherein before the identity verification procedure is performed, in the verification method, the identity registration procedure is performed at least once, and the identity registration procedure includes the following steps:

Step 1: detecting and acquiring, by the physiological characteristic detector, at least one piece of physiological characteristic check information of the user;

Step 2: converting, by the control module, the at least one piece of physiological characteristic check information into at least one physiological characteristic check value through the physiological characteristic computation unit, and transferring the physiological characteristic check value to the key unit; and

Step 3: encrypting, by the key unit, the physiological characteristic check value, and storing the encrypted physiological characteristic check value in the key unit.

Preferably, the non-contact identity verification method further includes Step 5: transferring, by a transmission unit, the comparison information to a system or apparatus in a wired or wireless transmission manner; and Step 6: if the comparison information is that verification succeeds, accepting, by the system or apparatus, login; or if the comparison information is that verification fails, rejecting, by the system or apparatus, login.

Preferably, in Step 2 of the identity verification procedure, the control module first performs preprocessing on the at least one piece of physiological characteristic verification information through a preprocessing unit, and further converts the at least one piece of preprocessed physiological characteristic verification information into the at least one physiological characteristic verification value through the physiological characteristic computation unit.

Therefore, in the present invention, the physiological characteristic detector is used to detect a human body in a non-contact manner, so that a conventional action of entering a password or a subscriber PIN may be avoided, thereby making verification more rapid and more convenient. Moreover, through the detection manner of the present invention, no harm is caused to a human body, thereby ensuring the safety of the human body. Besides, the detection manner of the present invention provides very high recognition stability, is applicable to various cases and scenarios, and has a recognition capability insusceptible to personal factors or an external environment. Moreover, in the present invention, a detected physiological characteristic of a human body may be encrypted and stored in a hardware security element, and personal physiological information of a user can be protected, thereby preventing a biometric characteristic of the user from being pried or stolen, thereby achieving very high information security.

### BRIEF DESCRIPTION OF THE DRAWINGS

To enable examiners to further understand objectives, features, and efficacy of the present invention, detailed description is provided below with reference to four preferred embodiments of the present invention and the accompanying drawings:

FIG. 1 is an architecture diagram of a non-contact identity verification device according to a first preferred embodiment of the present invention.

FIG. 2 shows a flow during the time when the non-contact identity verification device of FIG. 1 performs identity verification.

FIG. 3 shows a flow during the time when the non-contact identity verification device of FIG. 1 performs identity registration.

FIG. 4 is a schematic diagram for illustrating that a user approaches the non-contact identity verification device of FIG. 1 to perform verification.

FIG. 5 is a schematic diagram for illustrating that the non-contact identity verification device of FIG. 1 transmits comparison information to a system or apparatus.

FIG. 6 is an architecture diagram of a non-contact identity verification system according to a second preferred embodiment of the present invention, and shows a flow during the time when the non-contact identity verification system performs identity verification.

FIG. 7 is an architecture diagram of a non-contact identity verification system according to a third preferred embodiment of the present invention, and shows a flow during the time when the non-contact identity verification system performs identity verification.

FIG. 8 is a schematic diagram of one of the uses of the non-contact identity verification system of FIG. 7.

FIG. 9 is an architecture diagram of a non-contact identity verification system according to a fourth preferred embodiment of the present invention, and shows a flow during the time when the non-contact identity verification system performs identity verification.

FIG. 10 is a flowchart of an identity registration procedure of a non-contact identity verification method according to the present invention.

FIG. 11 is a flowchart of an identity verification procedure of a non-contact identity verification method according to the present invention.

### DETAILED DESCRIPTION OF THE PREFERRED EMBODIMENTS

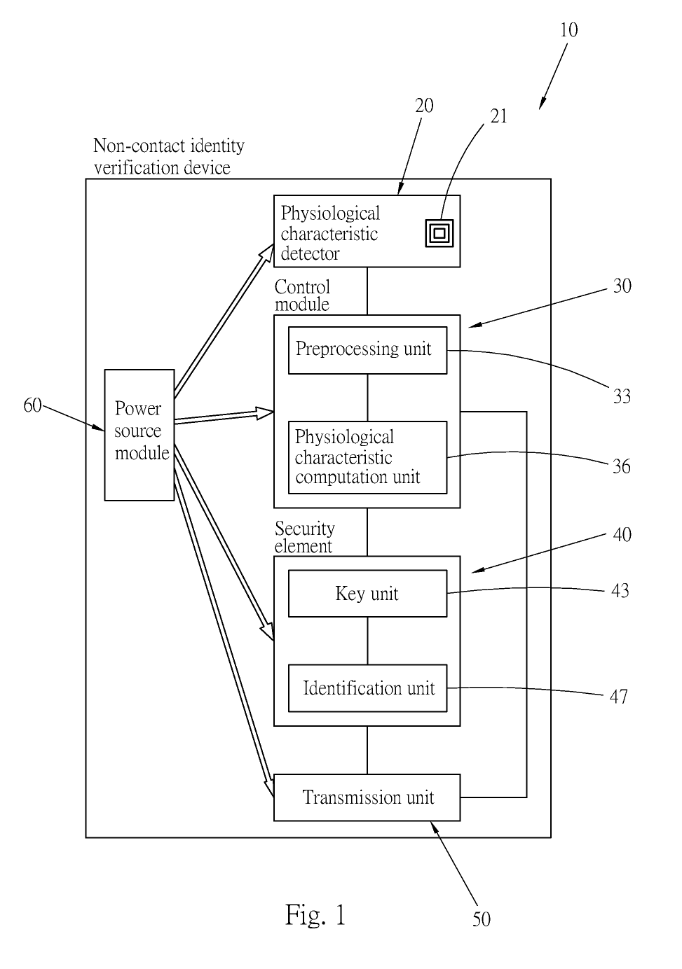

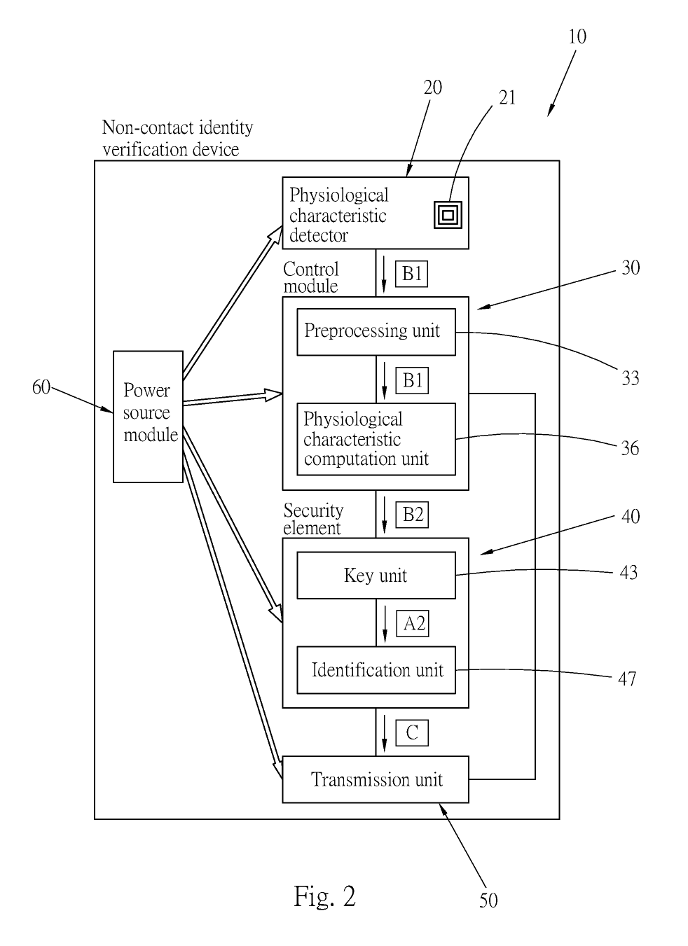

The present invention provides a non-contact identity verification technology, in which a physiological characteristic is verified, to recognize an identity of a user. Referring to FIG. 1 and FIG. 2, an identity verification technology provided in a first preferred embodiment of the present invention is a non-contact identity verification device 10, including: a physiological characteristic detector 20, a control module 30, a security element 40, a transmission unit 50, and a power source module 60, which are described as follows:

The physiological characteristic detector 20 has a miniature detection member, for example, a miniature radar. A detection antenna 21 is disposed on the miniature radar. The physiological characteristic detector 20 detects respiration, pulses, heartbeat, blood pressure or other physiological signals of a user through the detection antenna 21 of the miniature radar by using an NPNS technology or a UWB sensing technology, to acquire at least one piece of physiological characteristic verification information B1 of the user in real time.

The control module 30 has a preprocessing unit 33 and a physiological characteristic computation unit 36, and is connected to the physiological characteristic detector 20, the security element 40, and the transmission unit 50. The preprocessing unit 33 first performs preprocessing on the physiological characteristic verification information B1 generated by the physiological characteristic detector 20, wherein the preprocessing is, for example, but not limited to, noise cleaning, data conversion, and volume reduction performed on the physiological characteristic verification information B1, so as to make a physiological characteristic included in the physiological characteristic verification information B1 clearer and reduce a volume of the physiological characteristic verification information B1. The physiological characteristic computation unit 36 has at least one physiological characteristic computation method (not shown), and may convert the preprocessed physiological characteristic verification information B1 into at least one physiological characteristic verification value B2, which is used as a specific physiological characteristic value of a certain person.

It should be noted that, the preprocessing unit may be omitted in the control module 30, and another processing circuit, such as a microprocessor or a processing module, cooperating with the control module 30 may be used to perform preprocessing on the physiological characteristic verification information B1.

The security element 40 has a key unit 43 and an identification unit 47, wherein the key unit 43 and the identification unit 47 are connected to each other. The key unit 43 has at least one key computation method (not shown). The key unit 43 encrypts and stores at least one physiological characteristic check value A2 through the key computation method. The physiological characteristic check value A2 is only mentioned in brief here, and will be described in detail below. The physiological characteristic verification value B2 and the physiological characteristic check value A2 are respectively a specific physiological characteristic and a specific physiological password of a certain person. Different persons have respective specific physiological characteristics. The identification unit 47 is configured to compare the physiological characteristic verification value B2 with the physiological characteristic check value A2 and generate a comparison information C.

The transmission unit 50 is connected to the security element 40, and may transfer the comparison information C to a system or apparatus in a wired transmission manner (for example, through a transmission cable or a network cable) or in a wireless transmission manner (for example, through Bluetooth, radio frequency or WiFi).

The power source module 60 is a structure that provides electric power or obtains electric power from an electric power source, to enable the verification device 10 to obtain electric power to operate. In the present embodiment, the power source module 60 may be a mains power plug, a universal serial bus (USB) connector or a Lightning connector of the Apple Inc. or may be a rechargeable/non-rechargeable battery or a replaceable/non-replaceable battery. The power source module 60 is connected to the physiological characteristic detector 20, the control module 30, the security element 40, and the transmission unit 50, and may supply power to the physiological characteristic detector 20, the control module 30, the security element 40, and the transmission unit 50.

The power source module 60 has various manners of supplying power to related members. For example, the power source module 60 supplies power to the security element 40, and the security element 40 then supplies power to the physiological characteristic detector 20; or the power source module 60 synchronously supplies power to the control module 30, the security element 40, and the physiological characteristic detector 20; or the power source module 60 supplies power to the control module 30, and the control module 30 further synchronously supplies power to the security element 40 and the physiological characteristic detector 20. However, the present invention is not limited thereto.

It should be noted that, the power source module 60 may further have a switch (not shown). The switch may be configured to turn off the identity verification device 10 when the identity verification device 10 is not being used. Alternatively, a timer (not shown) may be disposed in the power source device 60. The timer may enable the identity verification device 10 to enter a sleep state after the identity verification device 10 is idle for a period of time.

The physiological characteristic detector 20, the control module 30, the security element 40, the transmission unit 50, and the power source module 60 of the present invention may be encapsulated in a same integrated circuit (IC) or different ICs. For example, the physiological characteristic detector 20 and the control module 30 are encapsulated in a same IC, or the physiological characteristic detector 20, the control unit 30 and the security element 40 are encapsulated in a same IC, or the physiological characteristic detector 20 and the transmission unit 50 are encapsulated in a same IC. However, the present invention is not limited thereto.

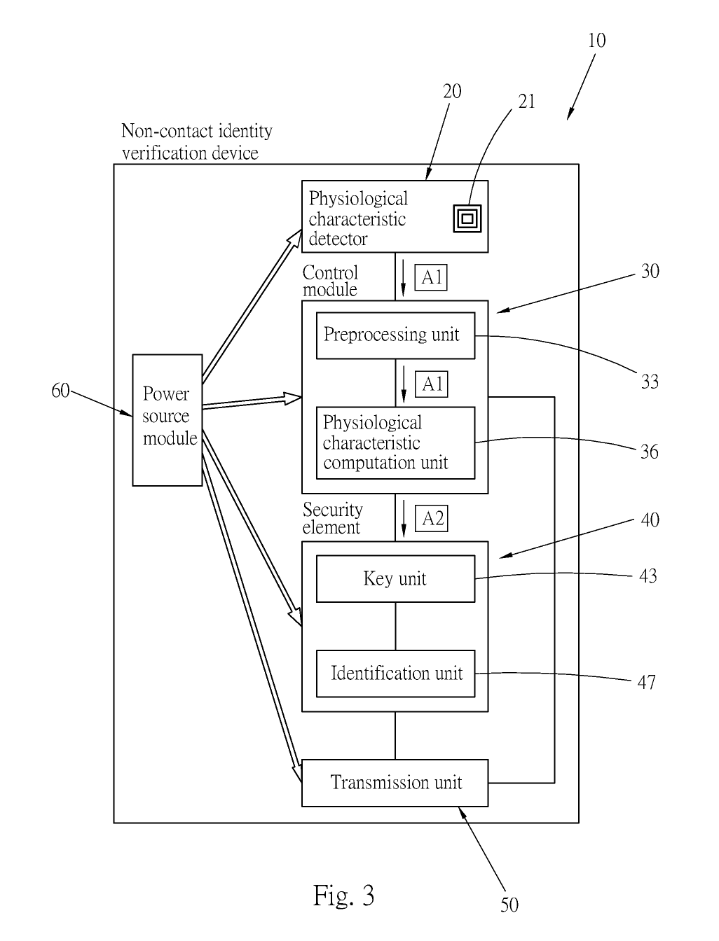

A use manner in the present embodiment is described below. Before a user intends to perform verification through the identity verification device 10, a physiological characteristic of the user is first registered in the security element 40 of the identity verification device 10 at least once, so that the key unit 43 prestores at least one physiological characteristic check value A2. First, referring to FIG. 3, the physiological characteristic detector 20 of the identity verification device 10 detects and acquires at least one piece of physiological characteristic check information A1 formed of the physiological characteristic of the user. The physiological characteristic check information A1 is preprocessed by the preprocessing unit 33 of the control module 30 and is converted by the physiological characteristic computation unit 36 into at least one physiological characteristic check value A2. The physiological characteristic check value A2 is encrypted by and stored in the key unit 43 of the security element 40. In this way, a specific and unique physiological characteristic certificate of a user is already stored in the identity verification device 10, and the identity verification device 10 may perform verification of a physiological characteristic, to complete identity authentication.

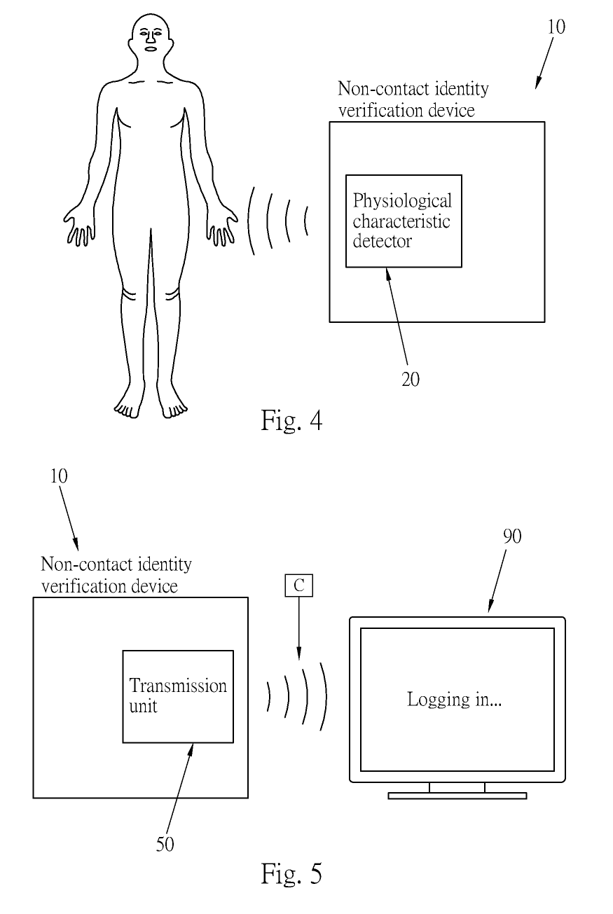

Referring to FIG. 2 and FIG. 4, in a verification technology in the present embodiment, the identity verification device 10 performs identity verification of a user before the user logs in to a system or apparatus. Before the user intends to perform identity verification, a human body characteristic value (that is, the physiological characteristic check value A2) encrypted through a key computation method is already prestored in the key unit 43 of the verification device 10. When the user intends to perform login, the user approaches the identity verification device 10 with the body (for example, a hand), and the physiological characteristic detector 20 of the identity verification device 10 detects a physiological signal of the user, generates physiological characteristic verification information B1, and then transfers the physiological characteristic verification information B1 to the control module 30.

It should be noted that, each time detection is performed, the physiological characteristic detector 20 acquires a physiological characteristic having the same property as the physiological characteristic check value A2. For example, if the physiological characteristic check value A2 is a value generated by detecting a pulse state, during identity verification, the physiological characteristic detector 20 also detects a pulse state of the user, to enable the verification device 10 to compare physiological characteristics having the same property, so as to perform identity verification.

After receiving the physiological characteristic verification information B1, the control module 30 first performs preprocessing on the physiological characteristic verification information B1 through the preprocessing unit 33, to make a physiological characteristic included in the physiological characteristic verification information B1 clearer and reduce a volume of the physiological characteristic verification information B1. Subsequently, the control module 30 further converts the preprocessed physiological characteristic verification information B1 into physiological characteristic verification value B2 through the physiological characteristic computation unit 36, and transfers the physiological characteristic verification value B2 to the identification unit 47 of the security element 40. In this case, the control module 30 also decrypts the physiological characteristic check value A2 prestored in the key unit 43 of the security element 40 and transfers the physiological characteristic check value A2 to the identification unit 47.

After receiving the physiological characteristic verification value B2 and the physiological characteristic check value A2, the identification unit 47 compares and analyzes the physiological characteristic verification value B2 and the physiological characteristic check value A2, generates a comparison information C according to a comparison result, and transmits the comparison information C to the transmission unit 50.

Referring to FIG. 5, after receiving the comparison information C, the transmission unit 50 then transmits the comparison information C to a system or apparatus (in the present embodiment, the system or apparatus is a computer 90). If the comparison result of the comparison information C is that verification succeeds, the user can log in to the computer 90. If the comparison result of the comparison information C is that verification fails, the user cannot log in to the computer 90.

During verification, if a distance between the user and the identity verification device 10 exceeds a detectable range of the physiological characteristic detector 20, a successful identity verification state of the identity verification device 10 is automatically canceled. The user needs to return into the detectable range of the physiological characteristic detector 20 to perform an identity verification operation again.

The non-contact identity verification device of the present invention is widely applicable, and can be disposed in a device or an apparatus such as a computer, a smart mobile phone, a tablet computer, an access control apparatus, an ATM, a home appliance, and a transportation vehicle. Because the identity verification device of the present invention verifies a physiological characteristic of a user in a non-contact detection manner, at the same time when the user approaches the identity verification device, the identity verification device completes an identity verification operation, so that verification efficiency is very high. Besides, members of the identity verification device of the present invention have low costs, and through the detection manner of the present invention, no harm is caused to a human body, thereby ensuring the body safety of the user and improving cost-effectiveness of the detection device. Moreover, the detection manner of the present invention provides very high recognition stability, and even if a user is injured or ill, wears thick clothes or gloves, or is in an adverse environment, the identity verification device of the present invention can still verify the user, having a recognition capability insusceptible to personal factors or an external environment. Moreover, during verification, the user does not need to take off clothes or gloves, so that verification of the user becomes more convenient. Still further, in the present invention, a detected physiological characteristic of the human body may be encrypted and stored in a hardware security element. In this way, it can be ensured that personal physiological information of the user is not pried or stolen by a malicious person, thereby improving information security of the identity verification device.

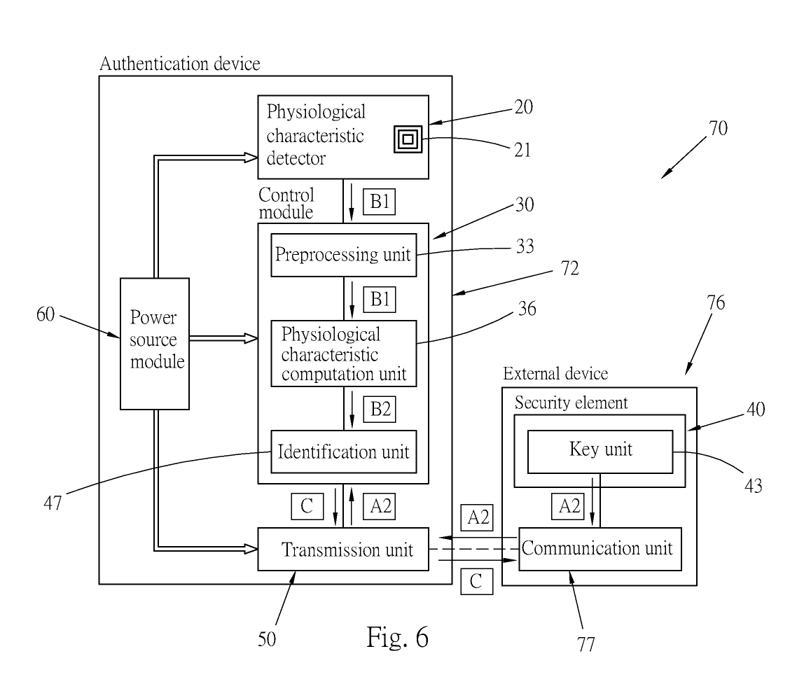

Referring to FIG. 6, an identity verification technology provided in a second preferred embodiment of the present invention is a non-contact identity verification system 70, including: a verification device 72 and an external device 76. The verification device 72 similarly includes a physiological characteristic detector 20, a control module 30, a transmission unit 50, and a power source module 60.

The control module 30 of the verification device 72 is connected to the physiological characteristic detector 20 and the transmission unit 50. The power source module 60 may supply power to the physiological characteristic detector 20, the control module 30, and/or the transmission unit 50. The control module 30 includes an identification unit 47.

The external device 76 may be, but not limited to, a device or an apparatus such as a computer, a smart mobile phone, a tablet computer, an access control apparatus, an ATM, a home appliance or a transportation vehicle. The external device 76 further has a communication unit 77.

The security element 40 includes a key unit 43, and is disposed in the external device 76. In the present embodiment, the security element 40 may be one of processor cores (for example, a Trusted Execution Environment (TEE)) built in the external device 76 (for example, a smart device), or an SIM or memory card (for example, a microSD) disposed in the external device 76. The security element 40 is connected to the communication unit 77.

Before the non-contact identity verification system 70 in the present embodiment is used, a user also needs to first register a physiological characteristic of the user in the security element 40 at least once, so that the key unit 43 of the security element 40 stores a physiological characteristic check value A2. A manner of registering the physiological characteristic of the user in the present embodiment is the same as that in the first preferred embodiment, and details are no longer described.

When a user intends to perform verification through the verification device 72 to log in to the external device 76, the physiological characteristic detector 20 of the verification device 72 detects a physiological signal of the user, generates physiological characteristic verification information B1, and transfers the physiological characteristic verification information B1 to the control module 30. The control module 30 then performs preprocessing on the physiological characteristic verification information B1 through the preprocessing unit 33, converts the preprocessed physiological characteristic verification information B1 into physiological characteristic verification value B2 through the physiological characteristic computation unit 36, and transmits the physiological characteristic verification value B2 to the identification unit 47.

In this case, the control module 30 enables the key unit 43 of the security element 40 disposed in the external device 76 to transmit the physiological characteristic check value A2 to the transmission unit 50 of the verification device 72 through the communication unit 77. The transmission unit then transmits the physiological characteristic check value A2 to the identification unit 47 of the control module 30. The identification unit 47 compares the physiological characteristic verification value B2 with the physiological characteristic check value A2, generates a comparison information C, and transmits the comparison information C to a communication unit 77 of the external device 76 through the transmission unit 50. If the comparison result of the comparison information C is that verification succeeds, the user may log in to the external device 76. If the comparison result of the comparison information C is that verification fails, the user cannot log in to the external device 76.

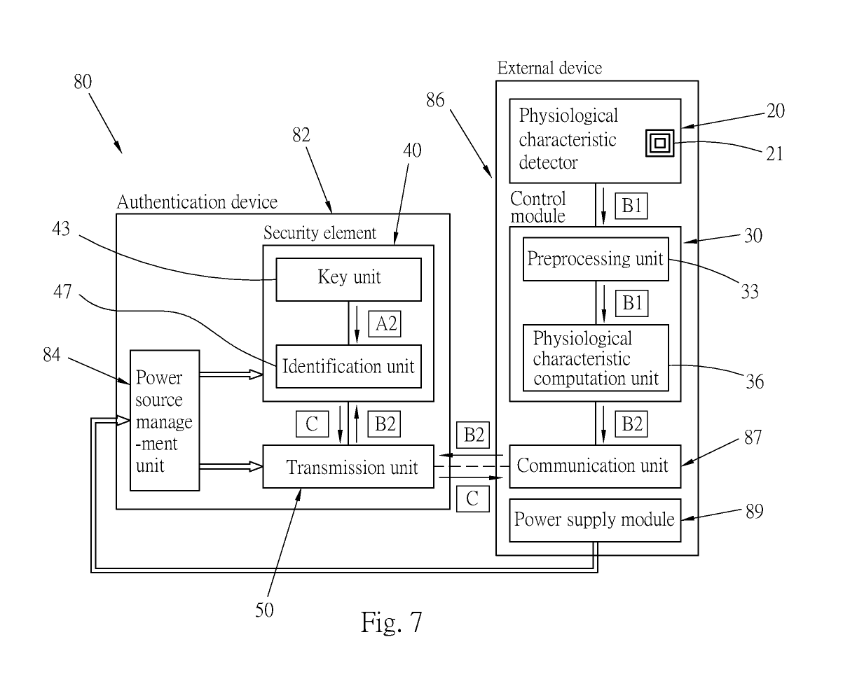

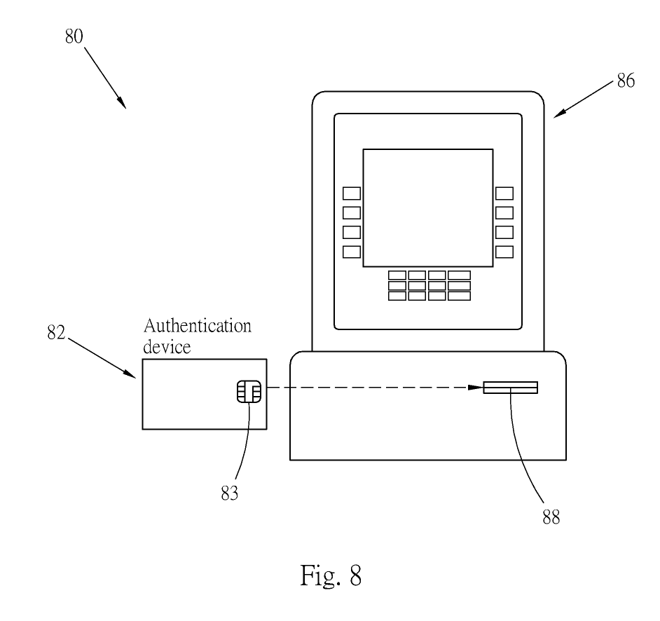

Referring to FIG. 7 and FIG. 8, an identity verification technology provided in a third preferred embodiment of the present invention is a non-contact identity verification system 80, including an authentication device 82 and an external device 86.

The authentication device 82 includes a security element 40 and a transmission unit 50. The security element 40 and the transmission unit 50 are connected to each other. The authentication device 82 further includes a power source management unit 84. The power source management unit 84 is connected to the security element 40 and the transmission unit 50. In the present embodiment, the authentication device 82 may be in a form of a card, for example, an ATM card or an electronic ticket. In the present embodiment, the authentication device 82 is an ATM card, and the security element 40 is disposed in a chip 83.

The external device 86 includes a physiological characteristic detector 20, a control module 30, and a power supply module 89. The physiological characteristic detector 20 and the control module 30 are connected to each other. The external device 86 further includes a communication unit 87. The communication unit 87 is connected to the control module 30. The external device 86 may be a card reader, an automatic add value machine or an ATM. In the present embodiment, the external device 86 is an ATM and is provided with a card insertion slot 88. A chip reader (not shown) is provided in the card insertion slot 88, and the communication unit 87 is disposed in the chip reader.

Therefore, referring to FIG. 8, the security element 40 of the verification device 82 in the present embodiment prestores a physiological characteristic check value A2 of a user. When the user intends to operate the external device (an ATM) 86 through the verification device (ATM card) 82, the user inserts the verification device 82 in the card insertion slot 88 of the external device 86, and connects the chip 83 of the verification device 82 to the chip reader in the card insertion slot 88 of the external device 86.

Referring to FIG. 7 again, when the verification device 82 is placed in the card insertion slot 88 of the external device 86, the power supply module 89 of the external device 86 may supply power to the power source management unit 84 of the verification device 82, to enable the power source management unit 84 of the verification device 82 to supply power to the security element 40 and/or the transmission unit 50, so that the security element 40 and/or the transmission unit 50 can operate with electric power of the power source management unit 84.

It can be understood that, if the external device 86 is a card reader, the card reader may be connected to a terminal (for example, a computer) through, for example, but not limited to, a USB connection cable or Lightning connection cable, to enable the computer to supply power to the external device 86. The power supply module 89 of the external device 86 supplies power to the power source management unit 84 of the verification device 82, to enable the verification device 82 to operate.

The physiological characteristic detector 20 of the external device 86 detects a physiological signal of the user, generates physiological characteristic verification information B1, and transfers the physiological characteristic verification information B1 to the control module 30. The control module 30 then performs preprocessing on the physiological characteristic verification information B1 through the preprocessing unit 33, converts the preprocessed physiological characteristic verification information B1 into physiological characteristic verification value B2 through the physiological characteristic computation unit 36, and transmits the physiological characteristic verification value B2 to the transmission unit 50 of the authentication device 82 through the communication unit 87. The transmission unit 50 transmits the physiological characteristic verification value B2 to the identification unit 47 of the security element 40. In this case, the control module 30 disposed in the external device 86 also sends the physiological verification check value stored in the security element 40 to the identification unit 47.

After receiving the physiological characteristic verification value B2 and the physiological characteristic check value A2, the identification unit 47 compares the physiological characteristic verification value B2 with the physiological characteristic check value A2, generates a comparison information C, and transmits the comparison information C to the communication unit 87 of the external device 86 through the transmission unit 50. If the comparison result of the comparison information C is that verification succeeds, the user can operate the external device 86. If the comparison result of the comparison information C is that verification fails, the user cannot operate the external device 86.

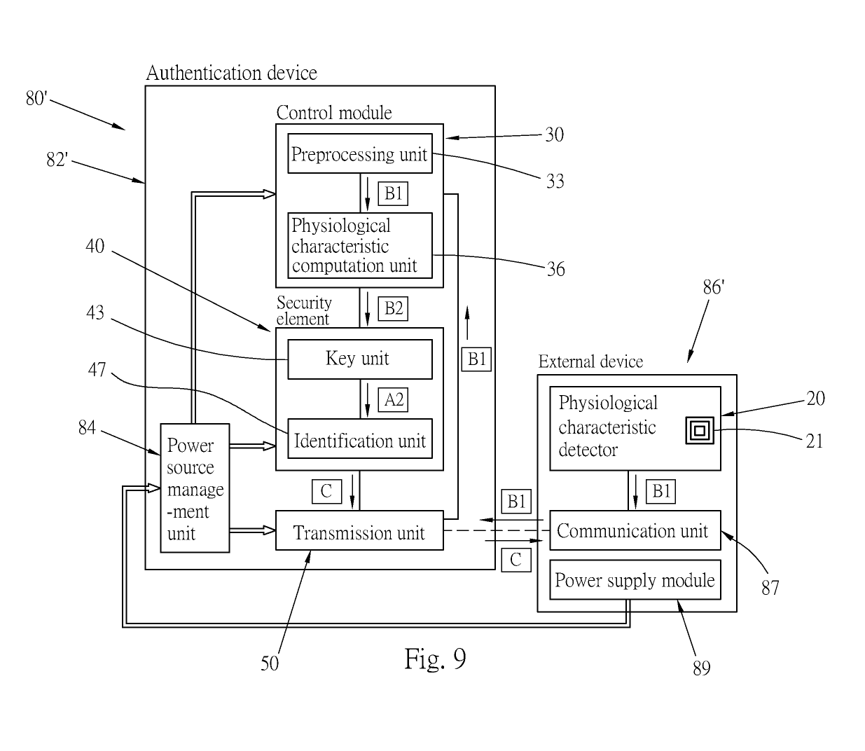

Referring to FIG. 9, an identity verification technology provided in a fourth preferred embodiment of the present invention is a non-contact identity verification system 80′, of which a structure is approximately the same as that in the third preferred embodiment. The non-contact identity verification system 80′ similarly includes an authentication device 82′ and an external device 86′, and the difference lies in the following:

The control module 30 is disposed in the authentication device 82′, and is connected to the security element 40 and the transmission unit 50. The power source management unit 84 is also connected to the control module 30, and can supply power to the control module 30. The physiological characteristic detector 20 of the external device 86′ is connected to the communication unit 87.

A use manner in the present embodiment may also be shown in FIG. 8. The authentication device 82′ may be an ATM card, the external device 86′ is an ATM, and similarly, the security element 40 of the authentication device 82′ already prestores a physiological characteristic check value A2 of a user. When the user operates the external device 86′ through the verification device 82′, the physiological characteristic detector 20 of the external device 86′ detects a physiological signal of the user and generates physiological characteristic verification information B1. The communication unit 87 transfers the physiological characteristic verification information B1 to the control module 30 through the transmission unit 50 of the authentication device 82′. The control module 30 then performs preprocessing on the physiological characteristic verification information B1 through the preprocessing unit 33, converts the preprocessed physiological characteristic verification information B1 into physiological characteristic verification value B2 through the physiological characteristic computation unit 36, and transmits the physiological characteristic verification value B2 to the identification unit 47 of the security element 40. In this case, the control module 30 also sends the physiological verification check value A2 stored in the key unit 43 of the security element 40 to the identification unit 47.

After receiving the physiological characteristic verification value B2 and the physiological characteristic check value A2, the identification unit 47 compares the physiological characteristic verification value B2 with the physiological characteristic check value A2, generates a comparison information C, and transmits the comparison information C to the communication unit 87 of the external device 86′ through the transmission unit 50. If the comparison result of the comparison information C is that verification succeeds, the user can operate the external device 86′. If the comparison result of the comparison information C is that verification fails, the user cannot operate the external device 86′.

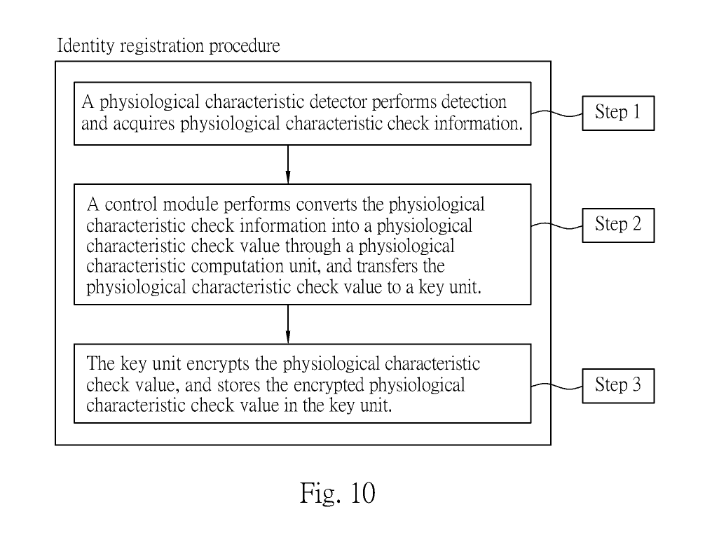

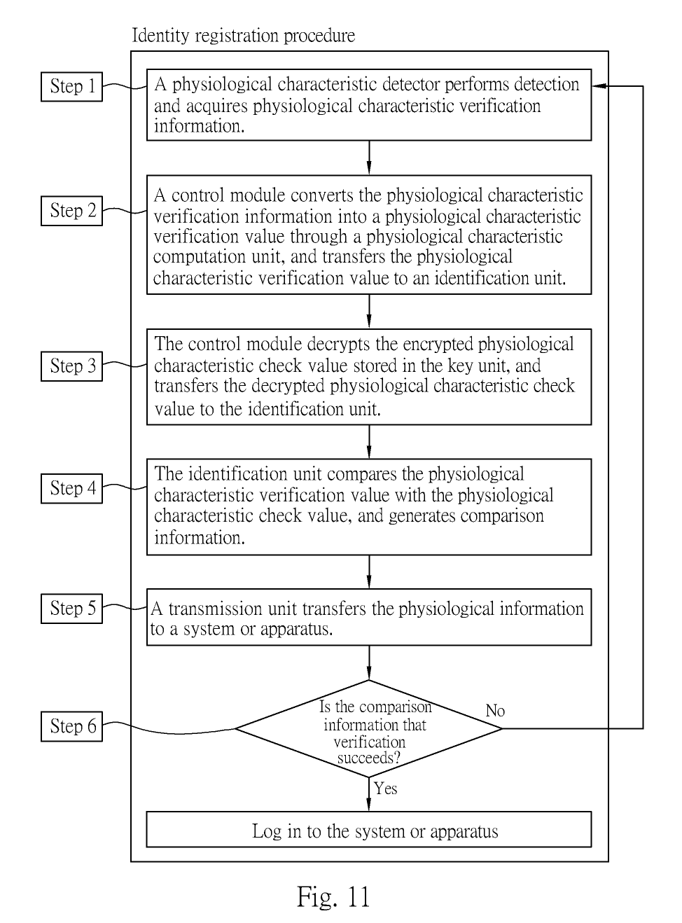

FIG. 10 and FIG. 11 are a system flowchart for describing a non-contact identity verification method of the present invention. The method includes: an identity registration procedure and an identity verification procedure. In the verification method, the identity verification procedure can be performed only after the identity registration procedure is performed at least once. Referring to FIG. 10, the identity registration procedure has the following steps:

Step 1: A physiological characteristic detector 20 detects a physiological signal of a user and acquires at least one piece of physiological characteristic check information A1.

Step 2: A control module 30 first performs preprocessing on the at least one piece of physiological characteristic check information A1 through a preprocessing unit 33, then converts the at least one piece of preprocessed physiological characteristic check information A1 into at least one physiological characteristic check value A2 through a physiological characteristic computation unit 36, and transfers the physiological characteristic check value A2 to a key unit 43.

Step 3: The key unit 43 encrypts the physiological characteristic check value A2 through at least one key computation method, and stores the encrypted physiological characteristic check value A2. The physiological characteristic check value 23 becomes a unique physiological characteristic recognition certificate of a certain user.

In this way, the key unit 43 stores the physiological characteristic check value A2 of the user, and verifies and compares an identity of the user by using the physiological characteristic check value A2, so that the user can perform the following identity verification procedure. Referring to FIG. 11, the identity verification procedure has the following steps:

Step 1: The physiological characteristic detector 20 detects a physiological signal of the user and acquires at least one piece of physiological characteristic verification information B1.

Step 2: The control module 30 first performs preprocessing on the at least one piece of physiological characteristic verification information B1 through the preprocessing unit 33, then converts the preprocessed physiological characteristic verification information B1 into at least one physiological characteristic verification value B2 through the physiological characteristic computation unit 36, and transfers the physiological characteristic verification value B2 to the identification unit 47.

Step 3: The control module 30 decrypts the encrypted physiological characteristic check value A2 stored in the key unit 43, and transfers the decrypted physiological characteristic check value A2 to the identification unit 47.

Step 4: The identification unit 47 compares the physiological characteristic verification value B2 with the physiological characteristic check value A2 and generates a comparison information C.

Step 5: A transmission unit 50 transfers the comparison information C to a system or apparatus in a wired or wireless transmission manner.

Step 6: The system or apparatus accepts or rejects login of the user according to the comparison information C. If the comparison information C is that verification succeeds, the system or apparatus accepts login of the user. If the comparison information C is that verification fails, the system or apparatus rejects login of the user, and the procedure returns to Step 1 to perform verification again.

When verification is interrupted (for example, when a position of the user exceeds a detectable range of the physiological characteristic detector 20), a successful verification state of the user is automatically canceled or terminated, and the user needs to perform the identity verification operation again.

The identity verification technology of the present invention covers technical fields such as a non-contact identity verification device and system and a method thereof, and may be widely applied to a device or an apparatus such as a computer, a smart mobile phone, a tablet computer, an access control apparatus, an ATM, a home appliance, and a transportation vehicle. In the present invention, a physiological characteristic detector is used to perform physiological detection on a user in a non-contact manner. When the user approaches the physiological characteristic detector, physiological characteristic information of the user can be rapidly and instantly detected. The user does not need to additionally enter any password or subscriber PIN, thereby making identity verification more rapid and more convenient. Besides, in the verification technology of the present invention, a physiological characteristic such as respiration, pulses, heartbeat or blood pressure of a user is detected in a non-contact manner, and no physiological damage is caused to the user. Even if the detection technology of the present invention is used for a long time to perform identity verification, the user is still not affected physiologically, thereby ensuring physiological safety of the user. Moreover, the detection manner of the present invention has a recognition effect insusceptible to personal factors or an external environment, and is applicable to various different cases and scenarios. Even if a user wears gloves or thick clothes, is injured or ill, is in an adverse environment (for example, high temperature or extreme cold) or undergoes a temporary change of a physical state (for example, before or after exercise), the physiological characteristic of the user can still be accurately detected and verified, so that recognition stability is very high. Still further, in the present invention, a detected physiological characteristic of a human body may be encrypted and stored in a hardware security element, and the physiological characteristic is not uploaded to another system or apparatus, so that personal physiological information of the user can be protected, and a biometric characteristic of the user is prevented from being pried or stolen, thereby achieving very high information security.

The embodiments disclosed above are only intended to describe rather than limit the present invention. Simple changes made by a person of ordinary skill in the art with the understanding of the technical measures of the present invention should all fall within the protection scope of the present invention. The non-contact identity verification device and system and the method thereof provided in the present invention are an innovative technique in the present technical field and have an inventive step, and an application is field in accordance with laws.

What is claimed is:

1. A non-contact identity verification device, comprising:
a physiological characteristic detector for detecting a physiological characteristic of a human body in a non-contact manner and generating at least one piece of physiological characteristic verification information;
a control module, having a physiological characteristic computation unit, the physiological characteristic computation unit converting the at least one piece of physiological characteristic verification information into at least one physiological characteristic verification value;
a key unit for prestoring at least one physiological characteristic check value;
an identification unit for comparing the physiological characteristic verification value with the physiological characteristic check value and generating a comparison information; and
a transmission unit for transferring, in a wired or wireless transmission manner, the comparison information generated by the identification unit.

2. The non-contact identity verification device according to claim 1, wherein: the physiological characteristic computation unit has at least one physiological characteristic computation method; the at least one piece of physiological characteristic verification information is converted into the at least one physiological characteristic verification value through the at least one physiological characteristic computation method; and the key unit has at least one key computation method, and the at least one physiological characteristic check value is encrypted and decrypted through the key computation method.

3. The non-contact identity verification device according to claim 1, further comprising: a security element, wherein the key unit and the identification unit are disposed in the security element.

4. The non-contact identity verification device according to claim 1, further comprising: a power source module, wherein the power source module is capable of supplying power to the physiological characteristic detector, the control module, the key unit, the identification unit and/or the transmission unit.

5. The non-contact identity verification device according to claim 1, wherein: the control module further comprises a preprocessing unit, wherein the preprocessing unit first performs preprocessing on the at least one piece of physiological characteristic verification information; and the physiological characteristic computation unit then converts the at least one piece of preprocessed physiological characteristic verification information into the at least one physiological characteristic verification value.

6. The non-contact identity verification device according to claim 1, wherein: the physiological characteristic detector performs detection by using a nanosecond pulse near-field sensing (NPNS) technology or an ultra wideband (UWB) sensing technology.

7. A non-contact identity verification system, comprising: a verification device and an external device, wherein:
the verification device comprises: a physiological characteristic detector, a control module, and a transmission unit, wherein the physiological characteristic detector is capable of detecting a physiological characteristic of a human body in a non-contact manner and generating at least one piece of physiological characteristic verification information; and the control module has a physiological characteristic computation unit and an identification unit, the physiological characteristic computation unit converting the at least one piece of physiological characteristic verification information into at least one physiological characteristic verification value;
the external device comprises: a key unit and a communication unit, wherein the key unit encrypts and stores at least one physiological characteristic check value, and the communication unit transmits the at least one physiological characteristic check value to the identification unit via the transmission unit of the verification device; and
the identification unit of the verification device compares the physiological characteristic verification value with the decrypted physiological characteristic check value and generates a comparison information, and the transmission unit may transfer the comparison information to the communication unit of the external device.

8. The non-contact identity verification system according to claim 7, wherein: the physiological characteristic computation unit has at least one physiological characteristic computation method; the at least one piece of physiological characteristic verification information is converted into the at least one physiological characteristic verification value through the at least one physiological characteristic computation method; and the key unit has at least one key computation method, and the at least one physiological characteristic check value is encrypted and decrypted through the key computation method.

9. The non-contact identity verification system according to claim 7, further comprising: a security element, disposed in the external device, wherein the key unit is disposed in the security element.

10. The non-contact identity verification system according to claim 7, wherein: the verification device further comprises a power source module, wherein the power source module supplies power to the physiological characteristic detector, the control module and/or the transmission unit.

11. The non-contact identity verification system according to claim 7, wherein: the control module further comprises a preprocessing unit, wherein the preprocessing unit first performs preprocessing on the at least one piece of physiological characteristic verification information; and the physiological characteristic computation unit then converts the at least one piece of preprocessed physiological characteristic verification information into the at least one physiological characteristic verification value.

12. The non-contact identity verification system according to claim 7, wherein: the physiological characteristic detector performs detection by using a nanosecond pulse near-field sensing (NPNS) technology or an ultra wideband (UWB) sensing technology.

13. A non-contact identity verification system, comprising: an authentication device and an external device, wherein:
the authentication device comprises: a key unit, an identification unit, and a transmission unit, wherein the key unit encrypts and stores at least one physiological characteristic check value;
the external device comprises: a physiological characteristic detector, a control module, and a communication unit, wherein the physiological characteristic detector detects a physiological characteristic of a human body in a non-contact manner and generates at least one piece of physiological characteristic verification information; the control module has a physiological characteristic computation unit, the physiological characteristic computation unit converting the at least one piece of physiological characteristic verification information into at least one physiological characteristic verification value; and the communication unit transmits the physiological characteristic verification value to the identification unit via the transmission unit of the authentication device; and
the identification unit of the authentication device compares the physiological characteristic verification value with the decrypted physiological characteristic check value and generates a comparison information, and the transmission unit may transfer the comparison information to the communication unit of the external device.

14. The non-contact identity verification system according to claim 13, wherein: the authentication device further comprises a security element, and the key unit and the identification unit are disposed in the security element.

15. The non-contact identity verification system according to claim 13, wherein: the external device further comprises a power supply module; and the authentication device further comprises a power source management unit, the power source management unit being capable of receiving electric power from the power supply module of the external device and supplying power to the key unit, the control module, the identification unit and/or the transmission unit.

16. The non-contact identity verification system according to claim 13, wherein: the control module further comprises a preprocessing unit, wherein the preprocessing unit first performs preprocessing on the at least one piece of physiological characteristic verification information; and the physiological characteristic computation unit then converts the at least one piece of preprocessed physiological characteristic verification information into the at least one physiological characteristic verification value.

17. The non-contact identity verification system according to claim 13, wherein: the physiological characteristic detector performs detection by using a nanosecond pulse near-field sensing (NPNS) technology or an ultra wideband (UWB) sensing technology.

18. A non-contact identity verification system, comprising an authentication device and an external device, wherein:
the authentication device comprises: a key unit, a control module, an identification unit, and a transmission unit, wherein the key unit encrypts and stores at least one physiological characteristic check value; and the control module has a physiological characteristic computation unit;
the external device comprises: a physiological characteristic detector and a communication unit, wherein the physiological characteristic detector detects a physiological characteristic of a human body in a non-contact manner and generates at least one piece of physiological characteristic verification information; and the communication unit may transfer the physiological characteristic verification information to the control module via the transmission unit of the authentication device; and
the physiological characteristic computation unit of the control module converts the at least one piece of physiological characteristic verification information into at least one physiological characteristic verification value; and the identification unit compares the physiological characteristic verification value with the decrypted physiological characteristic check value and generates a comparison information, and the transmission unit may transfer the comparison information to the communication unit of the external device.

19. The non-contact identity verification system according to claim 18, wherein: the physiological characteristic computation unit has at least one physiological characteristic computation method; the at least one piece of physiological characteristic verification information is converted into the at least one physiological characteristic verification value through the at least one physiological characteristic computation method; and the key unit has at least one key computation method, and the at least one physiological characteristic check value is encrypted and decrypted through the key computation method.

20. The non-contact identity verification system according to claim 18, wherein: the authentication device further comprises a security element, and the key unit and the identification unit are disposed in the security element.

21. The non-contact identity verification system according to claim 18, wherein: the external device further comprises a power supply module; and the authentication device further comprises a power source management unit, the power source management unit being capable of receiving electric power from the power supply module of the external device and supplying power to the key unit, the control module, the identification unit and/or the transmission unit.

22. The non-contact identity verification system according to claim 18, wherein: the control module further comprises a preprocessing unit, wherein the preprocessing unit first performs preprocessing on the at least one piece of physiological characteristic verification information; and the physiological characteristic computation unit then converts the at least one piece of preprocessed physiological characteristic verification information into the at least one physiological characteristic verification value.

23. The non-contact identity verification system according to claim 18, wherein: the physiological characteristic detector performs detection by using a nanosecond pulse near-field sensing (NPNS) technology or an ultra wideband (UWB) sensing technology.

24. A non-contact identity verification method, comprising an identity verification procedure, wherein the identity verification procedure comprises the following steps:
Step 1: detecting and acquiring, by a physiological characteristic detector, at least one piece of physiological characteristic verification information of a user in a non-contact manner;
Step 2: converting, by a control module, the at least one piece of physiological characteristic verification information into at least one physiological characteristic verification value through a physiological characteristic computation unit, and transferring the physiological characteristic verification value to an identification unit;
Step 3: decrypting, by the control module, at least one encrypted physiological characteristic check value stored in a key unit, and transferring the decrypted physiological characteristic check value to the identification unit; and
Step 4: comparing, by the identification unit, the physiological characteristic verification value with the physiological characteristic check value, and generating a comparison information.

25. The non-contact identity verification method according to claim 24, further comprising: an identity registration procedure, wherein before the identity verification procedure is performed, in the verification method, the identity registration procedure is performed at least once, and the identity registration procedure comprises the following steps:
Step 1: detecting and acquiring, by the physiological characteristic detector, at least one piece of physiological characteristic check information of the user in a non-contact manner;
Step 2: converting, by the control module, the at least one piece of physiological characteristic check information into at least one physiological characteristic check value through the physiological characteristic computation unit, and transferring the physiological characteristic check value to the key unit; and
Step 3: encrypting, by the key unit, the physiological characteristic check value, and storing the encrypted physiological characteristic check value in the key unit.

26. The non-contact identity verification method according to claim 24, further comprising:
Step 5: transferring, by a transmission unit, the comparison information to a system or apparatus in a wired or wireless transmission manner; and
Step 6: if the comparison information is that verification succeeds, accepting, by the system or apparatus, login; or if the comparison information is that verification fails, rejecting, by the system or apparatus, login.

27. The non-contact identity verification method according to claim 24, wherein: in Step 2 of the identity verification procedure, the control module first performs preprocessing on the at least one piece of physiological characteristic verification information through a preprocessing unit, and further converts the at least one piece of preprocessed physiological characteristic verification information into the at least one physiological characteristic verification value through the physiological characteristic computation unit.

28. The non-contact identity verification method according to claim 25, wherein in Step 2 of the identity registration procedure, the control module first performs preprocessing on the at least one piece of physiological characteristic check information through a preprocessing unit, and further converts the at least one piece of preprocessed physiological characteristic check information into the at least one physiological characteristic check value through the physiological characteristic computation unit.
